(19) United States
(12) Patent Application Publication
(10) Pub. No.: US 2004/0252515 A1
(43) Pub. Date: Dec. 16, 2004

(54) Lamp for use in a living space, especially a table or floor lamp

(76) Inventor: Harald Opolka, Solingen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/332,401

(22) PCT Filed: Dec. 22, 2001
(86) PCT No.: PCT/DE01/04954

(30) Foreign Application Priority Data
Jan. 20, 2001 (DE) 201 01 029.1
Jul. 14, 2001 (DE) 201 11 739.8

(51) Int. Cl. F21S 8/08

(52) U.S. Cl. 362/410

(57) ABSTRACT

The invention relates to a lamp for use in a living space, especially a table or floor lamp, comprising a lamp base (10), a lamp shaft (11), and a light source (12) that can be exchangeably fixed in sockets (13) mounted in the lamp shaft (11). According to the invention, the light source is a light-emitting diode (12) or consists of a plurality of light-emitting diodes, which is/are arranged inside the lamp shaft (11) and which illuminate(s) a luminescent body (26) exchangeably placed onto the end of the lamp shaft.

The invention relates to a living-space lamp, in particular a table or floor lamp having a lamp base, a lamp shaft, and a light source that is removably received in a socket in the shaft.

Standard table or floor lamps are provided with light bulbs that are screwed into sockets in which are provided contacts connected to a power source. An on/off switch provided in the circuit can be constituted as a level control when the lamp has two or more bulbs grouped together. Lamps with bulbs have however the disadvantage that a large portion of the energy consumed is wasted as heat with only a small portion being converted to light. Light bulbs with filaments also have a relatively short service life until the filament burns out.

Much better light output is achieved with krypton or halogen bulbs having prong-like contacts that are inserted into matching sockets.

It is an object of the present invention to provide a living-space lamp that uses electricity efficiently and that has a particularly advantageous structure.

This object is achieved by the living-space lamp according to claim 1, which is characterized in that

the light source is one or more light-emitting diodes that are mounted in the lamp shaft and that project light on a light-emitting body removably mounted on a lamp-shaft end.

Preferably the light-emitting body is rod or ball-shaped and is made of a transparent material. In particular glass or plastic is recommended which can if necessary be tinted or made partially transparent. The particular advantage of the living-space lamps according to the invention is that instead of relatively large incandescent bulbs which take up considerable space because of the heat they generate, it is possible to use small-volume light-emitting diodes that fit in the relatively slim shaft. Moving the light source into the lamp shaft or, when there is no lamp shaft, into the lamp base makes it possible to make the light-emitting body into which the light is projected from the source of virtually any shape. The exchangeability of this body allows lamp shape to be changed quickly. The light-emitting diode or diodes have a long service life so that as a rule the light-emitting diodes are changed never or very rarely.

Unlike the case for incandescent bulbs, which as a result of their limited service life have to be changed often, when using light-emitting diodes it is not necessary to provide the same access into the lamp shaft. A further advantage of light-emitting diodes is their energy-saving operation, using only 13% as much energy as is used by an incandescent bulb of similar light output.

Alternatively the light-emitting body can be a lamp shade with a sleeve- or ring-shaped holder that fits directly on the lamp shaft. While according to the state of the art lamp shades always must be mounted on the screw socket for the incandescent bulb and the lamp shade must be set at a considerable spacing from the incandescent bulb, according to the present invention there are no such restrictions.

According to a further feature of the invention the LED is provided in a hollow reflector having a rear opening through which it extends. This opening has a size that closely fits the shape of the light-emitting diode extending through it. Such a hollow reflector serves to increase the light output. Indeed the shape of the light-emitting diode glass body restricts the main beam direction of the light diodes to a limited arc, while the laterally diffused and lost light when no reflector is used is not inconsequential. Furthermore each diode is centered in its own reflector, that is the light diode can be perfectly oriented after fitting the reflector by simply bending their flexible mounting leads so that they can be aimed exactly longitudinally. The hollow reflector itself can be centered by its outside shape on the lamp shaft in a similar manner. When many light-emitting diodes are used, each light-emitting diode has its own reflector in which it is centered. If necessary the reflectors are arranged in a honeycomb in a one-piece body having an outer surface corresponding to a lamp-shaft inner surface.

The plurality of light-emitting diodes are operable individually or in groups by a control circuit. As known from floor or table lamps, the light intensity can be adjustable in steps. Controllers can also provide stepless adjustment. When different diodes are used, each with its own particular color spectrum, the color mix can be adjusted by the controller.

According to a further feature of the invention the rod-shaped, ball-shaped, or otherwise spherically shaped light-emitting body of plastic is solid and has an outer or inner surface shaped with recesses, raised parts, or thickened regions. Alternatively, the rod-shaped, ball-shaped, or otherwise spherically shaped body is hollow and is formed on its surfaces with raised, recessed, or thickened shapes. In all these described embodiments, regions are formed in the light-emitting body which have relative to the other regions a different optical refractive index. This leads to refraction and/or reflection of the light which make the shaped parts glow. In the simplest case of a solid body the shape can be made by simple partially roughing the surface of the shaped body, so that rings, spirals, or other shapes are formed in the surface by machining, by a laser, or be internal formation. In particular a laser treatment with the now possible focusing creates a local heating by means of which the hollow or solid body (the latter internally) can be shaped.

For manufacturing reasons it is advisable with certain spherical light-emitting bodies to produce two hemispheres and then fasten them together at their edges. In particular hollow bodies are produced by injection or blow molding.

A further variant of the living-space lamp according to the invention is produced when the lamp shaft is a rod-shaped flashlight and has an internal chamber that is adapted to hold batteries and that is closable by a battery-compartment cover after unscrewing the lamp shaft from the lamp base. In this manner it is possible to lift off the light-emitting body, unscrew the lap shaft, equip it with its own set of batteries (of the necessary capacity), and close the battery compartment with a cover, where-upon a switch on the lamp shaft makes it usable as a flashlight. The actual living-space lamp is in this case made such that in the lamp base there is a pin with a contact projecting out from its end and extending to the end of the battery compartment so as to serve as a switchable power source for the diodes when the lamp shaft is sitting in the lamp base.

Alternatively it is of course possible to completely do without an external power source and make the lamp base such that the battery-equipped flashlight is set in a seat in the lamp base. The light-emitting body is in this case made so that it can be snapped into place on the free end of the head of the flashlight.

Embodiments of the invention are shown in the drawing.

Therein:

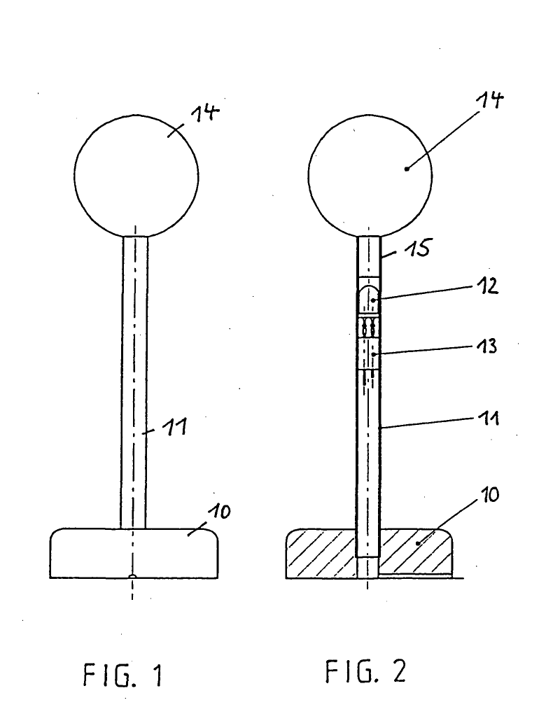

FIG. 1 is a side view of a first embodiment;

FIG. 2 is a section through the lamp of FIG. 1;

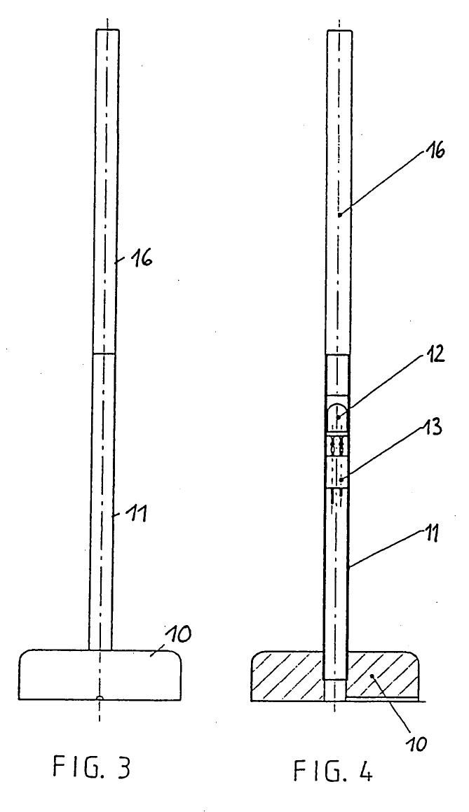

FIG. 3 is a side view of another embodiment;

FIG. 4 is a section through this other embodiment;

FIG. 5 is a partly sectional side view of yet another embodiment;

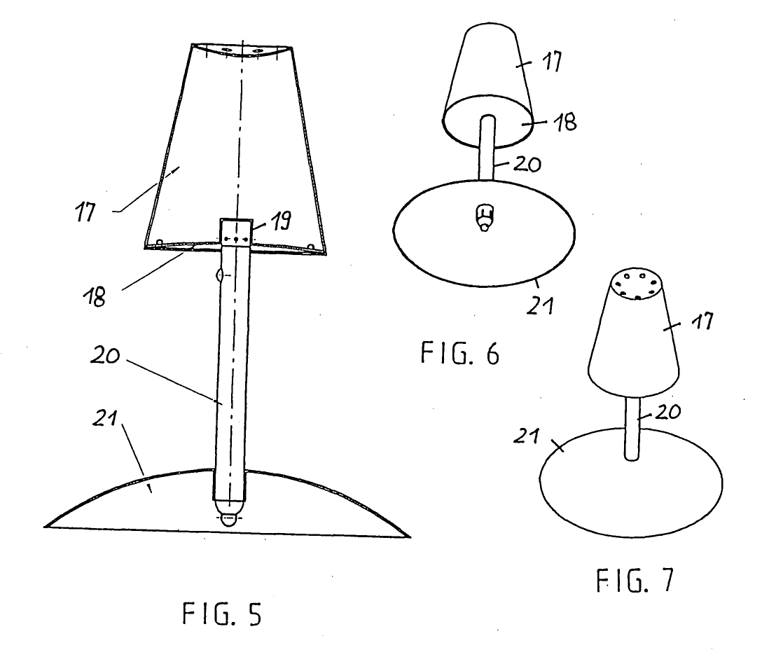

FIGS. 6 and 7 are perspective view of this embodiment in different directions;

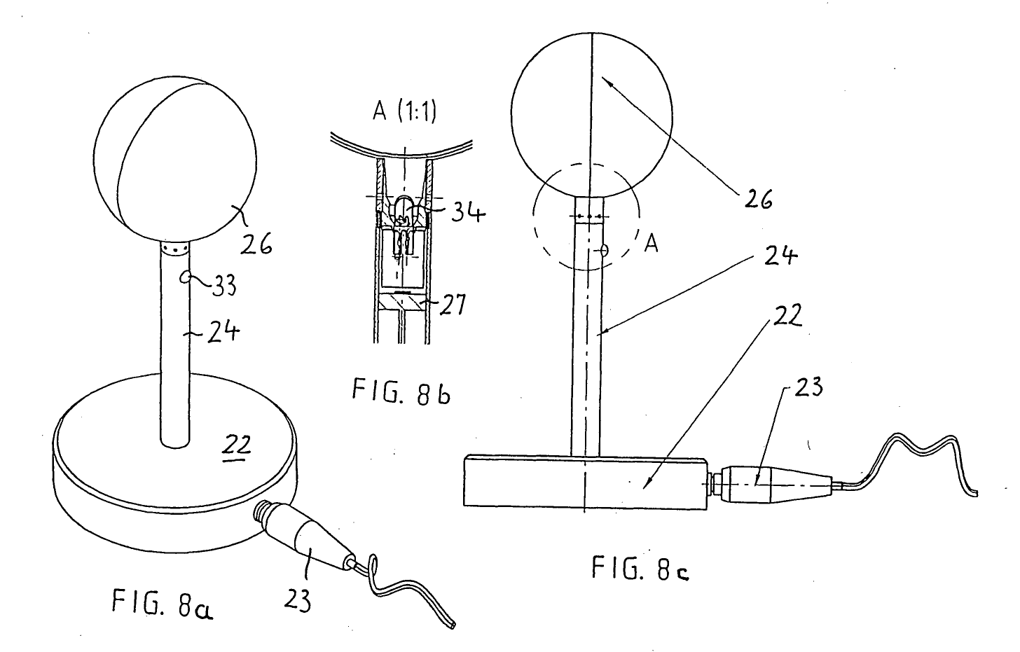

FIG. 8a through 8c are various views and sections of a further embodiment of the invention with a spherical light-emitting body;

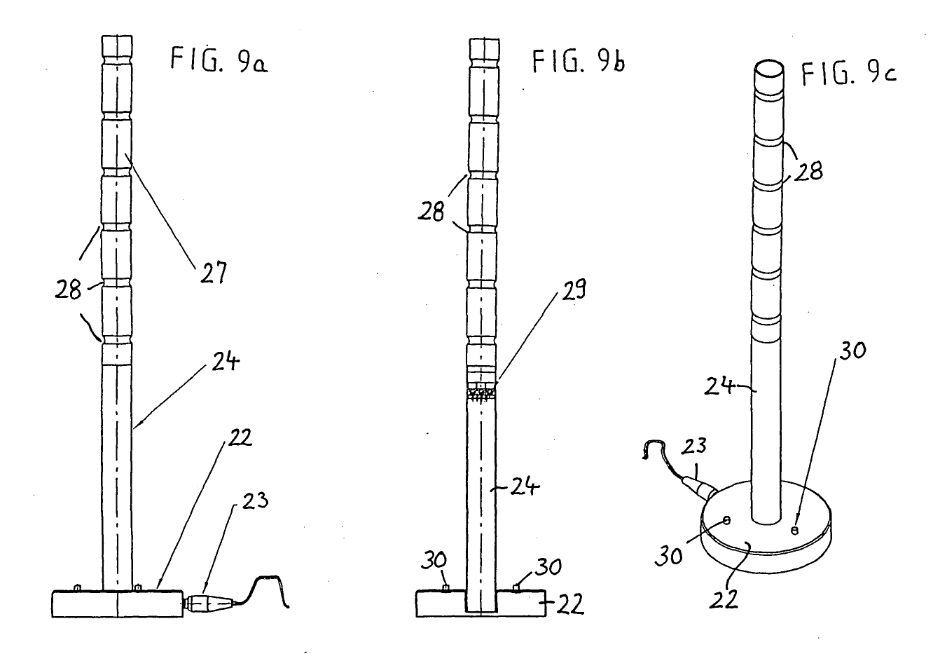

FIG. 9a through 9c are further embodiments of the lamp according to the invention with a rod-like light-emitting body on whose surface there are several annular recesses;

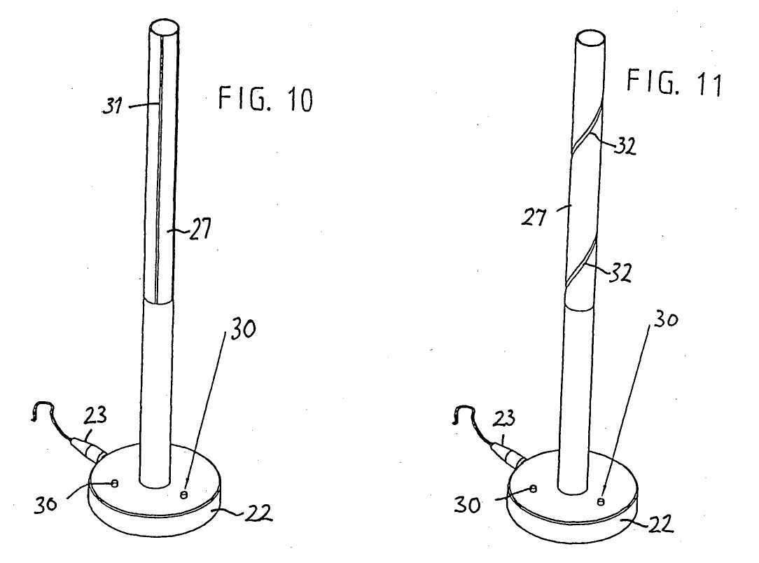

FIG. 10 is a perspective view of another embodiment with a rod-shaped light-emitting body with outside straight recesses; and

FIG. 11 is a perspective view of a lamp with a rod-shaped light-emitting body whose surface has spiral-shaped recesses.

The living-space lamp has a lamp base 10 that normally has a lateral cable groove through which the line cord extends. The lamp base can also if necessary hold a transformer unless the desired lamp-base size makes an external transformer necessary. Extending vertically upward from this lamp base is a lamp shaft 11 inside of which is a light-emitting diode 12 that is fitted to a socket 13. The light-emitting diode 12 has two wire-like contacts that, as is standard for halogen lamps, fit in respective sleeves that are supplied via electrical wires with current. The upper lamp-shaft end carries according to the invention a light-emitting body that as shown in FIGS. 1 and 2 can be an acrylic ball 14, here with a shaft extension 15 fitting over the end of the lamp shaft, or an acrylic rod 16 as in FIGS. 3 and 4 that in the illustrated embodiment is of the same diameter as the lamp shaft. As shown in FIG. 1 to 4, the same lamp base and shaft are used, but the light-emitting body is switchable so that as a result of the different shapes there is a considerable range of possibilities.

FIGS. 5, 6, and 7 show a lamp with a shade 17 whose lower side is formed by a generally closed cover 18 in whose center a generally sleeve-shaped socket 19 is provided that fits over the lamp shaft 20 that in this case is a rod-shaped flashlight with light-emitting diodes as the light source. This rod-shaped flashlight is inserted into a lamp base that has a central seat whose shape corresponds to that of the lower end of the flashlight. The shade can be lifted off such a lamp and the flashlight can be lifted out of the lamp base and taken away. The power source is formed by batteries inside the hollow lamp shaft or can alternately be an adapter that is connected with a standard socket via a transformer.

The living-room lamp (here a table lamp) shown in FIG. 8a to 8c has a disk-shaped lamp base 22 which has a socket in which is fitted a plug 23 for supplying current. A lamp shaft 24 threaded into the lamp base and extending upward corresponds to the lamp shaft 20 of the lamp of FIG. 5 and has an internal compartment holding batteries and closed at an end by a cover 25 (which is removable for installation of batteries) so that the lamp shaft 24 from which the light-emitting body 26 can be removed is usable as a flashlight. The lamp shaft has an on/off switch 25 by means of which the diode 26 (see FIG. 8b) can be turned on. In the condition of FIGS. 8a and 8c a contact post 27 extends into the battery compartment and supplies electricity to the diode through the switch 26. An open end of the lamp head has cylindrical extensions which are connected to the light-emitting body 26 so that the light-emitting body is a force fit or locked in place. The light-emitting body 26 is formed in this case of two ball-shaped hemispheres that are formed of molded plastic and fitted together on formation as a sphere.

Further embodiments of a living-space lamp that can serve as a table or floor lamp are shown in FIG. 9a to 9c, 10, and 11. Here a lamp base 22 is supplied with electricity via a plug 23. The light-emitting body is a generally rod-shaped and solid acrylic-glass body 27 in whose surface grooves 28 are cut. The lamp shaft 24 is provided at its upper end with several, for example eight, light-emitting diodes 29 that emit monochromatic light of various colors (e.g. red, blue, and green). There are for example three red, three blue, and two green light-emitting diodes, each diode color or each group of diodes with the same color being controlled by a respective switch 30 (the third switch is hidden in the drawing and not visible). When one or more of the diodes are switched on, the light beamed upward into the light-emitting body 27 is interrupted and reflected at the grooves 28 so that the grooves 28 appear as lighted rings.

The lamp shown in FIG. 10 is correspondingly constructed but has, instead of the annular grooves, longitudinal grooves 31 extending parallel to the longitudinal axis of the acrylic-glass body 2. The same is true for the lamp according to FIG. 11 where the grooves 32 are helical on the surface of the light-emitting body 27. These grooves can be formed by cutting tools, lasers, or other means. Instead of the grooves, rib-shaped projections of appropriate shape or other shapes, such as geometric shapes, representations, or the like, can be formed inside the body. In the lamps of FIG. 8 to 10 particular effects can be achieved in that the emitted light is broken up at interfaces or even reflected in some cases so that light is not only projected upward, but shed over an area (in FIG. 8 somewhat like an illuminated soap bubble or any other desired shape).

The desired effect can be increased when several diodes of different light colors are separately switchable or variable with respect to light intensity. In this case mixed colors can be produced that either stay constant over time or that are periodically or continuously varied. The number of color possibilities can be varied as well as the light intensity.

1. A living-space lamp, in particular a table or floor lamp having a lamp base (10, 21), a lamp shaft (11, 20), and a light source that is removably received in a socket in the shaft,
characterized in that the light source is one or more light-emitting diodes (12) that are mounted in the lamp shaft (11, 20) and that project light on a light-emitting body (14, 15; 16; 17) removably mounted on a lamp shaft end.

2. The living-space lamp according to claim 1, characterized in that the light-emitting body (14, 15, 16) is rod or ball-shaped and is made of a transparent material, preferably plastic.

3. The living-space lamp according to claim 1 or 2, characterized in that the light-emitting body is a lamp shade (17) with a sleeve- or ring- shaped holder that fits on the lamp shaft (20).

4. The living-space lamp according to one of claims 1 to 3, characterized in that the light-emitting diode (12) is provided in a hollow reflector having a rear opening through which it extends, this opening having a size that closely fits the shape of the light-emitting diode.

5. The living-space lamp according to one of claims 1 to 4, characterized in that a plurality of light-emitting diodes are provided in the lamp shaft, each diode being centered in its own reflector, all the reflectors being arranged in a honeycomb in a one-piece body having an outer surface corresponding to the lamp shaft inner surface.

6. The living-space lamp according to claim 5, characterized in that the light-emitting diodes (12) are operable individually or in groups by a control circuit.

7. The living-space lamp according to one of claims 2 to 6, characterized in that the rod-shaped, ball-shaped, or otherwise spherically shaped light-emitting body of plastic is solid and has an outer or inner surface shaped with recesses, raised parts, or thickened regions.

8. The living-space lamp according to one of claims 2 to 6, characterized in that the rod-shaped, ball-shaped, or otherwise spherically shaped body is hollow and is formed on its surfaces with raised, recessed, or thickened shapes.

9. The living-space lamp according to claim 8, characterized in that the ball-shaped or spherically shaped light-emitting body is formed of two mounted-together shells or hemispheres.

10. The living-space lamp according to claim 8 or 9, characterized in that the hollow body is formed by blow or injection molding.

11. The living-space lamp according to one of claims 1 to 10, characterized in that the lamp shaft is a rod-shaped flashlight and has an internal chamber that is adapted to hold batteries and that is closable by a battery-compartment cover after unscrewing the lamp shaft from the lamp base.
